(19) United States
(12) Patent Application Publication
(10) Pub. No.: US 2007/0157078 A1
(43) Pub. Date: Jul. 5, 2007

(54) METHOD FOR COMBINING INPUT DATA WITH RUN-TIME PARAMETERS INTO XML OUTPUT USING XSL/XSLT

(75) Inventor: Robert J. Anderson, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: DISCOVERY PRODUCTIONS, INC., Scottsdale, AZ (US)

(21) Appl. No.: 11/618,359

(22) Filed: Dec. 29, 2006

Related U.S. Application Data
(60) Provisional application No. 60/755,540, filed on Dec. 30, 2005.

(51) Int. Cl. G06F 17/00; G06F 7/00

(52) U.S. Cl. 715/513; 715/515; 707/100

(57) ABSTRACT

A system and method is disclosed for adding dynamic information to XML source data without substantial, or preferably any, modification of the underlying source code and without requiring the writing of any XSLT extension functions. The addition of dynamic information enables a user to customize XML source data for display based on parameters known only at run-time. The present invention receives various run-time and system parameters, uses the parameters to construct queries, and executes the queries against internal and/or external data sources. Datasets that are generated based on query execution are converted to XML document fragments and an XSL Transform converts the XML document fragments into a desired markup language file for presentation within a browser application.

### REFERENCE TO RELATED APPLICATION

This application claims priority to, and the benefit of, U.S. Provisional Patent Application Ser. No. 60/755,540, filed on Dec. 30, 2005, the entire contents of which are incorporated herein by reference.

### FIELD OF INVENTION

The present invention generally relates to the use of XSL and XSL Transforms to create XML packages, and more particularly, to a system and method for adding dynamic content to web pages within a complex web application environment without requiring modification of the underlying code.

### BACKGROUND OF THE INVENTION

The Extensible Stylesheet Language (XSL) is a language for defining how Extensible Markup Language (XML) source content should be presented in a given presentation medium. XSL Transformations (XSLT) are designed to be used as a part of XSL in order to describe how an XML document can be transformed into another markup language document. For example, in the case of web sites, XSL transforms, filters, sorts, and/or formats XML source code into HTML or some other recognizable form so that a web browser can display information on the resulting web page. Furthermore, XSL has the capability to display data based on test conditions and decisions made on elements within the XML source. The power of XSL, similar to many stylesheet languages, is that the XML source code need not be modified for each presentation medium in which one wishes to display information.

However, a drawback of XML and XSL is that once an XML document is constructed, the information is generally static. That is, one can make tests and decisions based upon elements existing in the source (e.g., conditional if loops), but supplementing the input data with additional run-time information becomes difficult. Due to the nature of XML, XSL, and XSLT incorporating these run-time parameters and data into the output and accessing this information so that it can be presented requires technical programming skills and/or writing XSLT extensions, which also require a high degree of technical programming skill. As a result, adding additional parameters, features, or website functionality can be time consuming, inconvenient, and costly.

Thus, there is a need for the ability to incorporate data only known at run-time into XML documents and provide access to dynamic information through the tools of XSL and XSLT that is truly usable by non-programmers and programmers alike.

### SUMMARY OF THE INVENTION

While the way in which the present invention address the disadvantages of the prior art will be discussed in greater detail below, in general, the present invention provides a method for allowing the addition of dynamic content to XML source data without substantial, or preferably any, modification of the underlying source code. In accordance with various embodiments of the present invention, the system takes an input dataset or SQL statement and combines it with system and/or customer parameters to produce output in either XML or HTML format.

Specifically, the system enables developers to create a specialized XML file, which will be referred to herein as an XmlPackage. The XmlPackage is provided with data via a dataset or SQL statement. Data sets are produced from the queries created from these parameters and converted into XML language fragments to form an XML Data Document that is compliant with desired markup language standards. The fully formed document is then transformed into the desired markup language using, for example, XSLT.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is a block diagram illustrating the major system components for an exemplary XmlPackage creation and execution in accordance with an embodiment of the present invention;

FIG. 2 is a flow chart illustrating exemplary processing steps for constructing dynamic markup language content based on an XmlPackage in accordance with an embodiment of the present invention; and,

FIG. 3 is a block diagram illustrating exemplary XmlPackages for creating XML document fragments that are combined to produce an XML Data Document in accordance with an embodiment of the present invention.

### DETAILED DESCRIPTION

The following descriptions are of exemplary embodiments of the invention only, and are not intended to limit the scope or applicability of the invention in any way. Rather, the following description is intended to provide convenient illustrations for implementing various embodiments of the invention. As will become apparent, various changes may be made in the compositions described in these embodiments without departing from the spirit and scope of the invention.

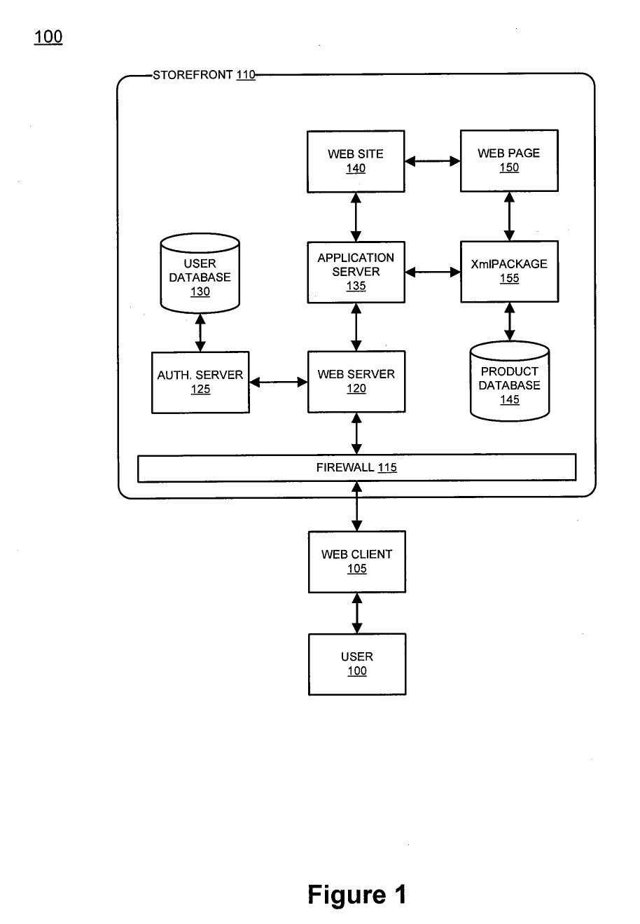

With reference to FIG. 1, in one embodiment, the system facilitates interaction between a user 100 and a storefront server 110 through a web client 105. One skilled in the art will appreciate that storefront 110 is merely one exemplary embodiment of the system and method discussed herein. FIG. 1 provides an example application of an exemplary XmlPackage in order to provide a better understanding of the invention and does not limit the scope of the invention. The invention contemplates a similar XmlPakaging system for use within any other data-driven environment were there is a need to enable programmers and non-programmers to efficiently build functionality into existing applications where code manipulation may otherwise be required.

Web client 105 is connected to a web server 120 through a network connection. Web server 105 may employ an authentication server 125 in order to validate and assign proper permissions to authorized users of system 100. User database 130 stores credentials and permissions specific to each user. Web server 120 also employs an application server 135 to manage various applications utilized by system 100. In exemplary embodiments, application server 135 may be a stand-alone server or may comprise software residing within web server 120. Furthermore, communications between web client 105, web server 120, and any other component of system 100 may be facilitated through the transmission of data over a network such as, for example, Internet, Intranet, LAN, WAN, and the like.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

In one embodiment, XmlPackage 155 is invoked by application server 135 in response to a request from web page 150 in order to query and format data from product database 145 or from any other source for display at web client 105. While shown in FIG. 1 as accessing web site 140 through application server 135, those skilled in the art will appreciate that web client 105 may connect with various components of storefront 110 either directly or indirectly through another system component. To maintain information relating to various products and/or services, web site 140 retrieves and stores product data and/or service data within product database 145.

In addition to the components discussed above, storefront 110 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; asset data; enterprise data, loan data; financial institution data; and/or like data useful in the operation of the invention.

As will be appreciated by one of ordinary skill in the art, the invention may be embodied as a customization of an existing system, an add-on product, upgraded software, a standalone system (e.g., kiosk), a distributed system, a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

User 100 may include any individual, business, entity, government organization, software and/or hardware which interact with storefront 110 to enter, edit and/or view information relating to one or more products and/or services offered for sale. User 100 may be, for example, a customer who accesses web site 140 to shop and facilitate online purchases. In another example, user 100 may be an administrator who authors and/or utilizes one or more XmlPackages 155 to modify the appearance of web pages or to customize content based on runtime and system parameters. In one embodiment, system 100 may provide limited or restricted access for certain people or groups, such as, for example, customers, employees, or any other third party with an interest in viewing and/or modifying web site 140. User 100 may interface with storefront 110 via any communications protocol, device or method discussed herein or known in the art. In one embodiment, user 100 may interact with the invention via an Internet browser at a web client 105.

Web client 105 may comprise any hardware and/or software suitably configured to facilitate input, receipt and/or review of any information related to storefront 110 or any information discussed herein. Web client 105 may include any device (e.g., personal computer), which communicates (in any manner discussed herein) with the invention via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that web client 105 may or may not be in direct contact with the storefront 110. For example, web client 105 may access the services of the storefront 110 through another server, which may have a direct or indirect connection to web server 120.

As those skilled in the art will appreciate, web client 105 may include an operating system (e.g., WINDOWS NT, 95/98/2000, OS2, UNIX, LINUX, SOLARIS, MACOS, etc.) as well as various conventional support software and drivers typically associated with computers. The web client 105 may include any suitable personal computer, network computer, workstation, minicomputer, mainframe or the like. Web client 105 can be in a home or business environment with access to a network. In an exemplary embodiment, access is through a network or the Internet through a commercially available web-browser software package.

Web client 105 may be independently, separately or collectively suitably coupled to the network via data links which includes, for example, a connection to an Internet Service Provider (ISP) as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The invention contemplates uses in association with web services, utility computing, pervasive and individualized computing, security and identity solutions, autonomic computing, commodity computing, mobility and wireless solutions, open source, service oriented architecture, biometrics, grid computing and/or mesh computing.

Web server 120 may include any hardware and/or software suitably configured to facilitate communications between web client 105 and one or more storefront 110 components. Further, web server 120 may be configured to transmit data to web client 105 within markup language documents. Web server 120 may operate as a single entity in a single geographic location or as separate computing components located together or in separate geographic locations. Requests originating from client browser 105 may pass through a firewall 115 before being received and processed at web server 120. As used herein, “transmit” may include sending electronic data from one system component to another over a network connection. Additionally, as used herein, “data” may include encompassing information such as commands, queries, files, data for storage, and the like in digital or any other form. Web server 120 may provide a suitable web site 140 or other Internet-based graphical user interface which is accessible by users 100. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.98). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

In one embodiment, firewall 115 comprises any hardware and/or software suitably configured to protect storefront 110 components from users of other networks. Firewall 115 may reside in varying configurations including Stateful Inspection, Proxy based and Packet Filtering among others. Firewall 115 may be integrated as software within web server 120, any other system component or may reside within another computing device or may take the form of a standalone hardware component.

In one embodiment, applications server 135 includes any hardware and/or software suitably configured to serve applications and data to a connected web client 105. Like web server 120, applications server 135 may communicate with any number of other servers, databases and/or components through any means discussed herein or known in the art. Further, applications server 135 may serve as a conduit between web client 105 and web site 140. Web server 120 may interface with applications server 135 through any means discussed herein or known in the art including a LAN/WAN, for example. Application server 135 may further interact with XmlPackage 155, product database, authentication server 125, or any other storefront 110 component in response to a user 100 request.

In one embodiment, web page 150 comprises any markup language document that may be viewed with in a browser application at web client 105. Such markup languages may include presentational markup, procedural markup, and descriptive markup. Web page 150 may further include references to external programmatic functions for performing complex computations, for example, as well as one or more XmlPackages suitably configured to render web page 140 and provide content in accordance with an administrators specifications. Practitioners will appreciate that web site 140 may be accessed via application server 135 or directly by way of web server 120. For example, application server 135 may reside as a web server application such as Apache HTTP Server™, Microsoft Internet Information Server™ (IIS), Sun Java System Web Server™, Zeus Web Server™, and the like.

To control access to web server 120 or any other component of the invention, web server 120 may invoke an authentication server 125 in response to submission of user 100 authentication credentials received at web server 120. In one embodiment, authentication server 125 includes any hardware and/or software suitably configured to receive authentication credentials, encrypt and decrypt credentials, authenticate credentials, and grant access rights according to user 100 pre-defined privileges attached to the credentials. Authentication server 125 may grant varying degrees of application and data level access to user 100 based on user information stored within user database 130.

In one embodiment, user database 130 includes any hardware and/or software suitably configured to facilitate storing authentication and/or privilege information relating to users 100. Product database 145 stores data relating to product information, as well as any other related information as disclosed herein. One skilled in the art will appreciate that the invention may employ any number of databases in any number of configurations. For example, a database may be employed to store functions and/or parameters that are used by XmlPackage 155 to render web page content in a specific manner. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The software elements of the present invention may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

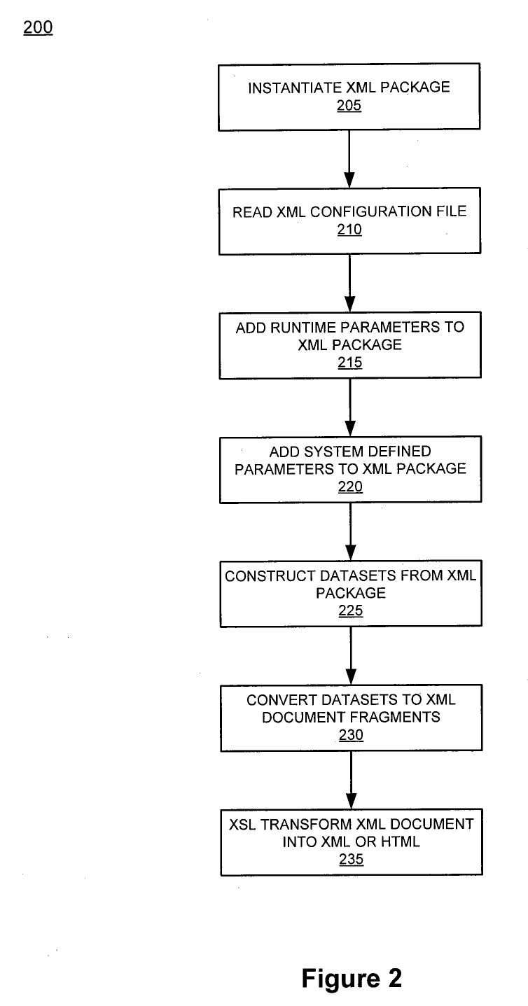

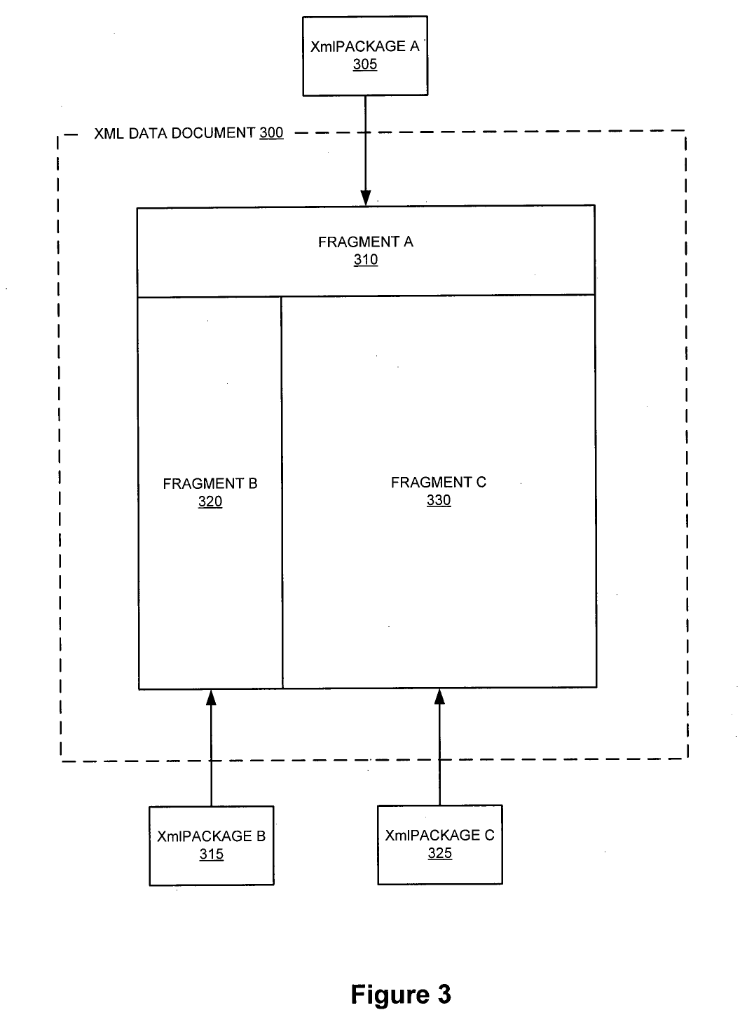

Referring now to FIGS. 3 and 4, the process flow and block diagram represent mere embodiments of the invention and are not intended to limit the scope of the invention as described herein. For example, the steps recited in FIG. 2 may be executed in any order and are not limited to the order presented. It will be appreciated that the following description makes appropriate references not only to the steps and user interface elements depicted in FIGS. 2 and 3, but also to the various system components as described above with reference to FIG. 1.

The present invention generally allows the addition of dynamic information to XML source data without substantial, or preferably any, modification of the underlying source code and without requiring the writing of any XSLT extension functions. Addition of dynamic information enables a user to customize XML source data for display based on parameters known only at run-time (e.g., identity of the currently logged in user). For example, in accordance with one embodiment, XML source data may comprise product and pricing information intended to be displayed via a web client 105. The pricing information is based on the category of customer accessing the product information, which is known only at run-time of a particular web page 150. The present invention enables the addition of this run-time information into the XML document so that this information is available to the XSL Transform. As a result, the browser (or in the case on server side transformations, the server) can display the proper product pricing in accordance with the customer's category. Though the present invention has been described in the context of a web site, any presentation medium now known or hereafter devised utilizing XML, XSL or similar technology is intended to be within the scope of the invention.

In accordance with various embodiments of the present invention, an initial source data set formatted in XML is combined with system and/or other parameters, and then output in a specified format, for example, XML. In accordance with one embodiment of the present invention, initial XML source data may comprise information about products, product categories, varying price levels and other information typically associated with selling products and/or services. Even though the XML source data has been described in the context of an e-commerce site, the XML source data can be data from any source.

In accordance with various embodiments of the present invention, run-time parameters are added to the initial source data for easy access, retrieval, and decision making directly in the XSLT transform logic, for example, by using simple XPath query syntax. For example, in accordance with many embodiments, initial XML source data is combined with run-time parameters that may comprise data retrieved via SQL statements. In other embodiments, run-time data may be retrieved via external data sources via URL. In another embodiment, the run-time data may comprise a well-formed XSL transform element.

In accordance with various embodiments of the present invention, system-defined parameters are added to the initial source data. For example, initial XML source data is combined with system-defined parameters that may comprise user session information, server information (e.g., web server or SQL server settings), page names, date and/or time, TCP/IP, and/or web form information. In a preferred embodiment of the present invention, a system designed for storefronts may include further information such as customer information (e.g., customer ID or customer name) that may stay constant for a particular customer login session.

In accordance with various embodiments of the present invention, data sets are created from query statements embedded in the package. For example, data is retrieved according to SQL, web, or other queries present in the input data set, or added via the run-time parameters or system. In various embodiments of the present invention, these data sets represent a robust set of data available to later operations involved in producing final output. In other words, the data sets produced may provide a user with a wide range of choices for inclusion into the final XML output. For example, in a storefront website, the data set may include all the products available to any given customer at price levels designated for the customer's category.

In accordance with various embodiments of the present invention, data sets are converted into coded fragments and combined with system and run-time data, which form a fully formed document. In accordance with various embodiments, the data sets, fragments, and fully formed document are formatted as XML. For example, data retrieved from an SQL query is converted to a document fragment, in the form of XML, associated with that particular query. Other system data and run-time data may be assembled in a similar manner creating multiple document fragments. These document fragments are “stitched” together into a document compliant with standardized document rules of a markup language such as, for example, XML.

In accordance with various embodiments of the present invention, the fully formed document is transformed into a form suitable for display. For example, in accordance with one embodiment, XML is transformed into HTML for display through a web browser using XSL Transforms. The fully formed document typically contains more information than desired for display to an end user or customer. The transformation enables a developer or user to apply logic rules to generate suitable final output.

As used herein, an XmlPackage 155 accepts data input in the form of a dataset or SQL statement, combines the data input with runtime and/or system parameters, retrieves data from an internal and/or external source, and produces an output in a markup language format suitable for display within an Internet browser at web client 105. According to an exemplary embodiment, XmlPackages can be classified as Internal Packages or Display Rendering Packages.

Internal Packages are code level XmlPackages that provide efficient access to nested entity and object structures in a database. Internal Packages are specifically designed for a web application and would most likely be supplied by a web application developer to enable web site administrators to configure the web application at the data level. Internal Packages typically produce an in-memory XML Document Object, as a result of SQL statements and various runtime, system, and user defined parameters.

Display Rendering Packages enable web site administrators to customize the appearance of web pages. A web application developer, or any other third party, may develop Display Rendering Packages, without substantive knowledge of the underlying code of the web application. For example, a web site administrator could define font type, font color, background color, border, and other display preferences within an XmlPackage. Display Rendering Packages output HTML to be rendered within the structure of an existing web page.

With reference to FIG. 3, exemplary process steps resulting in the rendering of a markup language document based on an XmlPackage is disclosed. When a web page is loaded, a call instantiates the appropriate XmlPackage according to file location and file name (step 300). The XmlPackage reads a corresponding XML configuration file or schema, which defines the specification for the XmlPackage (step 305). Practitioners will appreciate that various methods and schema languages may be incorporated to define the XmlPackage including, for example, DTD (Document Type Definition), XML Schema, RELAX NG, and ISO DSDL (Document Schema Description Language).

When a request is received at web server 120 for a web page 150, certain pieces of information are known that may define the nature and structure of the content that will be included in the web page. For example, because the Internet is a stateless environment, the identity of user 100 may not be known until a request is processed. The request itself may contain an identifier for user 100 that is obtained through a cookie, hidden web page field, or maintained in a session token. Information known only at runtime will herein be referred to as runtime parameters. Thus, appropriate runtime parameters are retrieved and added to the XmlPackage (step 315). System defined parameters may also be added to the XmlPackage (step 320). System defined parameters may include, for example, system date, system time, server operating system, client operating system, browser version, IP address, and the like.

Runtime parameters and system parameters are then combined in order to construct datasets (step 325). Datasets may be constructed by any means known in the art for collecting relevant data in a computing environment. In one embodiment, system 300 constructs a SQL statement based on the runtime and/or system defined parameters. For example, an XmlPackage may be designed to provide product information that is most pertinent to the user. Thus, the user's identifier that is collected as a runtime parameter may be used to construct a query that selects all of the products purchased by the identified user over the past one year. In another embodiment, system 300 may use such parameters to construct a web search, as will be described in greater detail herein.

When retrieved, datasets are converted to XML document fragments (step 330). A document fragment is a file which may be inserted as the content of the root element (or any other element) of an XML file. In other words, XML document fragments comprise specific content that when combined with other XML document fragments, make up the sum content of an XML Data Document. As any number of XmlPackages may be employed to render a web page, each may create its own one or more XML document fragment(s), the XML document fragments may be combined with system data (also XML document fragments) to form a XML Data Document. Using Extensible Style Language Transformation (XSLT), the XML Data Document is transformed into the desired markup language as to be viewable within a web browser (step 335) at web client 105.

Practitioners will appreciate that the content of an XmlPackage may vary, however and exemplary XmlPackage may comprise SQL queries, web queries, XSL Transforms, search engine setting definitions, post processing queries, and set cookie instructions. The configuration and usage of each of these XmlPackage elements will be described in greater detail herein. Practitioners will appreciate that XmlPackages may contain elements in additional to those described without departing from the spirit and scope of the invention. Furthermore, the following descriptions of the structural elements of an exemplary XmlPackage are not intended to limit the scope of the invention. For example, naming conventions may vary as defined by a file or schema.

SQL Queries

SQL queries may be added to an XmlPackage in order to retrieve data from one or more databases. Such data may include, for example, product names, descriptions, costs, shipping information, and the like. According to one embodiment, the query elements is defined within the XmlPackage tags as follows:

<query name=“Sections” rowElementName=“Section” runif=“paramname”>

The name attribute may be used to identify the root child element in the XML Data Document for the above example. The optional “runif” attribute may be used to execute the query and may include a query string parameter, form parameter, cookie parameter, or an AppConfig parameter. In one embodiment, if a parameter is not specified, then the SQL query will not execute. For example, if a web page contains a form field that is required for inclusion within the SQL query, then the query will not execute until the web page is submitted to web server 120 with the filled form field.

According to one embodiment, a query parameter may be defined as either a “queryparam” element or a “querystringreplace” element. A queryparam element defines a parameter that is evaluated at execution time and may be formatted as “@paramname,” for example. Thus, for each queryparam element, there should be a @paramname variable within the SQL statement, (e.g., “select * from product_info where prod_id=@productid”). The queryparam element may have any number of attributes for defining, for example, a parameter name, parameter type, request parameter name, SQL data type, default value, validation pattern, and the like.

The “querystringreplace” element renders the SQL statement dynamically in terms of its table names, fields names, “where” clause fields, and “order by” clause fields. Thus, an XmlPackage containing a SQL query can accept inputs in the form of runtime and/or system parameters to replace querystringreplace elements and retrieve customized data at runtime. The querystringreplace element may have any number of attributes for defining, for example, a replace tag, replace type, replace parameter name, default value, and validation pattern. Below is an example of a SQL query definition as it might be defined within an XmlPackage.

<query name=“Entities” rowElementName=“Entity”>

<sql>

<![CDATA[

select Name,Description from {EntityName} with (NOLOCK) where
{EntityName}ID=@EntityID

]]>

</sql>
<querystringreplace replaceTag=“{EntityName}”

replacetype=“runtime”
replaceparamname=“EntityName”
defvalue=“”
vpatern=“(category)|(section)|(affiliate)|(manufacturer)|(distributor)|(library)”/>

<queryparam paramname=“@EntityID”

paramtype=“runtime”
requestparamname=“EntityID”
sqlDataType=“int”
defValue=“0”
vpattern=“” />

</query>

The above SQL query definition would produce an XML document fragment similar to the following:

<Entities>

<Entity>

<Name>Test Entity1</Name>
<Description>Test Description</Description>

</Entity>
<Entity>

<Name>Test Entity2</Name>
<Description>Test Description</Description>

</Entity>

...
</Entities>

The query element may further contain an XSL Transform element (e.g., “querytransform”) that may configure the output XML in a different format than what was returned from the database prior to adding the output XML to the final XML Data Document. For example, a query of a “products” table may return a list of product names in a first column and a list of corresponding product prices in a second column. The web site administrator may want the display of products and prices to include a specific header in accordance with the current date. The administrator may further want to set the font of the product data and add a specific border. Thus, an XSL Transform element may be used to format the product data in accordance with an XSL stylesheet.

Web Queries

Web queries enable an XmlPackage to retrieve data from an external data source by way of a Universal Resource Locator (URL). When included in the XmlPackage, a URL returns XML and/or ASCII text data. For example, a “name” attribute may identify the specific node within the XML Data Document for which returned content is to be inserted. The URL element specifies the URL of a web document, including querystring parameters. The “querystringreplace” element is used for web queries in much the same manner as used within SQL queries. The querystringreplace element describes a tag within the URL string that may be replaced by a value from a request variable, a runtime variable, or AppConfig parameter. The querystring replace element may further identify an XSL Transform to transform returned content, thereby adding transformed data to the XML Data Document rather than the raw results obtained from the URL.

### EXAMPLE

<webquery name=“WebData1” RetType=“xml”>

<url>http://www.somesite.com/xmldatafeed.aspx?param1={param1
}</url>
<querystringreplace replaceTag=“{param1 }”
replacetype=“request”

replaceparamname=“productid” defvalue=“0”
validationpattern=“\hat{ }\d{1,10}$”/>

</webquery>

XSL Transform

Markup language output of an XmlPackage is obtained by applying an XSL Transform to an XML Data Document that contains SQL data, web data, and system data. Thus, an XmlPackage may include a transform element such as, for example, “<PackageTransform>.” In one embodiment, an XmlPackage does not require execution of a query element; however the <PackageTransform> may be a required element and should define a valid XSLT stylesheet. The XmlPackage may utilize extension objects from any number of programming languages in order to implement high-level logic that is not otherwise available in normal XSL. Accordingly, new namespaces may be added to the XSL stylesheet in order to call the appropriate extension objects. To reference the appropriate namespace, a “xsl:stylesheet” element may include, for example, the attribute xmlns:aspdnsf=“urn:aspdnsf.”

### EXAMPLE

<xsl:stylesheet version=“1.0”
xmlns:xsl=“http://www.w3.org/1999/XSL/Transform”

xmlns:aspdnsf=“urn:aspdnsf”>

According to one embodiment, an XmlPackage may include an output element in order to specify the desired markup language format for XSL output.

### EXAMPLE

<xsl:output method=“html” omit-xml-declaration=“yes” />

Search Engine Settings

In some instances, it may be desirable to define the page title, keyword Meta tags, description Meta tags, SectionTitle, and No Script sections of a markup language file. These items may be defined by adding a “SearchEngineSetting” node to the XmlPackage and further including one or more of the following child nodes: “SectionTitle”, “SETitle”, “SEKeywords”, “SEDescription”, and “SENoScript.” Each node may contain an XPath statement, an XSLT stylesheet, or static text. The nodes may specify its content (e.g., “xpath”, “transform”, or “text”) within the node's “actionType” attribute. The XPath statement or stylesheet is executed against the Xml Data Document. If the node contains an XPath statement, it returns a single node. This may be desirable when a value for a single Xml Data Document element is needed. To combine data from an XML Data Document, a stylesheet may be further specified. Below is an example how the setting are defined.

<SearchEngineSettings>

<SETitle actionType=“transform”>

<xsl:stylesheet version=“1.0”
xmlns:xsl=“http://www.w3.org/1999/

XSL/Transform”
xmlns:aspdnsf=“urn:aspdnsf”>

<xsl:output method=“html”
omit-xml-declaration=“yes” />
<xsl:template match=“/”>

<xsl:value-of
select=“concat(/root/Sections/Section/SEName, ‘-’,

/root/Sections/Section/Description)” />

</xsl:template>

</xsl:stylesheet>

</SETitle>
<SEKeywords actionType=“xpath”>

/root/Sections/Section/SEKeywords

</SEKeywords>
<SEDescription actionType=“text”>

This is my static text to use for the search engine
description meta tag

</ SEDescription>

</SearchEngineSettings>

Post Processing

Post processing enables the XmlPackage to execute processing instructions after an XML data Document is produced and prior to executing a XSL transform. Such processing instruction may include, for example, executing SQL statements for database inserts and updates, web queries, setting cookie values, setting session values, and the like. Thus, the XmlPackage may further include such processing instructions in order to perform operations that are dependent on the processes and/or data that is used to construct the XML Data Document. For example, an XmlPackage may be constructed to perform a web query to retrieve product information from a defined URL. Returned product data from the URL is processed in accordance with the above and is transformed into an XML Data Document. The XmlPackage may contain post processing instructions in order to insert the returned product data into a local products database. Thus, a “postprocess” element may be used to define post processing routines within the XmlPackage.

Query After

Similar to the post processing element disclosed above, an XmlPackage may include a query after element (e.g., “queryafter”). Query after elements define SQL queries that are to be executed after the XML Data Document is produced. The query after element operates much as the <query> element, with the exception that the <querystringreplace> and <queryparam> elements may draw their values from the XML Data Document (using an XPath statement). This may be desirable in order to, for example, perform an update on a database table after retrieving the data for the XSL Transform. Moreover, the <queryafter> element may contain a “runif” element in order to prevent a defined query from executing prematurely. The runif element tests for the existence of a specified value or element. If the value or element does not exist or is empty, then the query is not executed.

### EXAMPLE

<queryafter>

<sql>
<![CDATA[

update customer set lastlogin=datetime where
customerid=@custid

]]>
</sql>
<queryparam paramname=“@ custid”
paramtype=“xpath”

requestparamname=“/root/System/CustomerID”
sqlDataType=“int”
defvalue=“0” validationpattern=“” />

</queryafter>

A web query after element (e.g., “webqueryafter”) is very similar as the “webquery” element described above, however an XPath statement in the “querystringreplace” element may be defined according to a value from a node in the XML Data Document. Also, as in the case of the “queryafter” element, the “webqueryafter” element includes a “runif” element in order to prevent a defined query from executing. If a parameter specified in a “paramtype” and “paramsource” attributes does not exist or is empty, then the query is not executed.

### EXAMPLE

<webqueryafter>

<url>http://webservice.externalsite.com/xmldata.aspx?param1={param 1}</url>
<querystringreplace

replaceTag=“{param1 }”
replacetype=“xpath”
replaceparamname=“/root/EntityHelpers/Category/Entity[1]/EntityID”
defvalue=“”
validationpattern=“” />

<runif paramtype=“appconfig” paramsource=“MyCustomAppConfigParam” />

</webqueryafter>

FIG. 3 is a block diagram showing how multiple XmlPackages may be applied to construct an XML Data Document. In accordance with the above described XmlPackage elements, an XmlPackage may be referenced within the body of a markup language document to retrieve and format data in a manner consistent with the requirements of a web site. According to the example set forth in FIG. 3, XmlPackage A 305 may be called to construct a header portion of the XML Data Document 310. XmlPackage A 305 executes a web query to retrieve data from a specified URL, which is then used to produce document fragment A. Simultaneously, or shortly thereafter, XmlPackage B 315 executes a SQL query against a product category table to retrieve a listing of available product categories and uses the returned data to produce document fragment B 320. XmlPackage C 325 executes a SQL query against a promotions table to produce document fragment C 330. Document fragment A 310, document fragment B 320, and document fragment C 330 are combined to produce an XML Data Document 300, which is converted to a markup language document by way of XSL Transform.

Finally, it should be understood that various principles of the invention have been described in illustrative embodiments. However, many combinations and modifications of the above-described formulation, proportions, elements, materials and components, used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

I claim:

1. A computer implemented method for adding dynamic data to a markup language file comprising:
receiving a request, wherein said request includes a package identifier;
invoking a package corresponding to said package identifier, wherein said package at least one of: explicitly and implicitly retrieves runtime data;
creating a dataset based on said runtime data; and,
invoking a transform to process said dataset, wherein said processing constructs a document.

2. The method of claim 1, wherein said document is at least one of: eXtensible Markup Language (XML), HyperText Markup Language (HTML), XmlPackage, JavaScript, ASCII text, and delimited text

3. The method of claim 1, wherein said runtime data comprises data known over the duration of at least one of: a session and a program execution.

4. The method of claim 1, wherein said package is an eXtensible Markup Language (XML) package.

5. The method of claim 1, wherein said dataset is an eXtensible Markup Language (XML) file.

6. The method of claim 1, wherein said transform is an Extensible Stylesheet Language (XSL) Transform.

7. The method of claim 1, wherein said request is instantiated by a call from at least one of: a markup language, a scripting language, and program code.

8. The method of claim 1, wherein said document is an eXtensible Markup Language (XML) document fragment.

9. The method of claim 1, wherein said transform invokes a second package.

10. The method of claim 1, wherein said package comprises a data section and a transformation section.

11. The method of claim 10, wherein said data section defines how data is retrieved and said transformation section defines additional package calls.

12. The method of claim 1, wherein said request includes a parameter comprising at least one of: a runtime parameter, a system parameter, and a form parameter.

13. The method of claim 1, wherein said package includes at least one of: a Structured Query Language (SQL) query, web query, eXtensible Stylesheet Language (XSL) Transform, search engine setting, post processing query, set cookie instruction, and reference to a second package.

14. The method of claim 1, wherein said package includes a query element and an eXtensible Stylesheet Language (XSL) Transform element.

15. The method of claim 1, wherein said package includes a Uniform Resource Locator (URL) for retrieving data from a web site.

16. The method of claim 1, wherein said package includes a reference to an extension object comprising high level programming code.

17. The method of claim 1, wherein said markup language file is at least one of: HyperText Markup Language (HTML), eXtensible Markup Language (XML), and eXtensible Stylesheet Language (XSL).

18. A machine-readable medium having stored thereon a plurality of instructions, the plurality of instructions when executed by a processor, cause the processor to perform a method comprising the steps of:
receiving a request, wherein said request includes a package identifier;
invoking a package corresponding to said package identifier, wherein said package at least one of: explicitly and implicitly retrieves runtime data;
creating a dataset based on said runtime data; and,
invoking a transform to process said dataset, wherein said processing constructs a document.
